(19) United States
(12) Patent Application Publication
(10) Pub. No.: US 2014/0132716 A1
(43) Pub. Date: May 15, 2014

(54) THREE-DIMENSION IMAGE FORMAT CONVERTER AND THREE-DIMENSION IMAGE FORMAT CONVERSION METHOD THEREOF

(71) Applicant: Realtek Semiconductor Corporation, Hsinchu (TW)

(72) Inventors: Wen-Chi LIN, Yunlin County (TW); Hsu-Jung TUNG, Hsinchu County (TW); Tseng I. LIN, Kaohsiung City (TW); Chihsiung CHENG, Hsinchu City (TW)

(73) Assignee: Realtek Semiconductor Corporation, Hsinchu (TW)

(21) Appl. No.: 14/073,626

(22) Filed: Nov. 6, 2013

(30) Foreign Application Priority Data
Nov. 13, 2012 (TW) 101142119

(51) Int. Cl. H04N 13/00

(52) U.S. Cl. CPC H04N 13/0029
USPC 348/43

(57) ABSTRACT

A three-dimension (3D) image format converter and a 3D image format conversion method thereof are provided. The 3D image format converter includes a memory, an input circuit, a control circuit, and an output circuit. The input circuit receives a first 3D image signal. The control circuit determines a first permutation way and a second permutation way according to the first 3D image signal belonging to one of a frame transmission mode and a line transmission mode, writes the first three-dimension image signal into the memory in the first permutation way and reads out the first three-dimension image signal from the memory in the second permutation way to generate a second 3D image signal belonging to the other of the frame transmission mode and the line transmission mode. The output circuit outputs the second three-dimension image signal.

This application claims the benefit of priority based on Taiwan Patent Application No. 101142119 filed on Nov. 13, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a three-dimension (3D) image format converter and a 3D image format conversion method thereof More particularly, the 3D image format converter and the 3D image format conversion method thereof of the present invention can convert a 3D image signal between the frame transmission mode and the line transmission mode.

2. Descriptions of the Related Art

As people's demands for audio & video (AV) entertainment increase, conventional two-dimension (2D) images have not been able to satisfy people's needs for image presentation. To achieve a more realistic image presentation effect, 3D image displays have gradually become mainstream products in the market.

3D image formats include a frame sequential format, a frame packing format, a top-and-bottom format, a field alternative format, a side by side format and a line alternative format. The frame sequential format, the frame packing format, the top-and-bottom format and the field alternative format belong to a frame transmission mode, while the side by side format and the line alternative format belong to a line transmission mode.

However, 3D image displaying apparatuses commercially available usually can only either support the frame transmission mode or the line transmission mode. Therefore, 3D image displaying apparatuses that support only the frame transmission mode are unable to receive and process image signals of the line transmission mode, and vice versa. This will cause consumer trouble in choosing 3D image displaying apparatuses and related products (e.g., multimedia players).

Accordingly, it is important to provide a solution capable of converting a 3D image signal between the frame transmission mode and the line transmission mode and providing the converted signal to various 3D image displaying apparatuses to improve user convenience in choosing the 3D image displaying apparatuses and related products.

### SUMMARY OF THE INVENTION

An objective of the present invention is to provide a three-dimension (3D) image format converter and a 3D image format conversion method thereof The 3D image format converter of the present invention can determine a first permutation way and a second permutation way according to an inputted 3D image signal belonging to one of a frame transmission mode and a line transmission mode to convert the 3D image signal between the frame transmission mode and the line transmission mode. Thus, when being installed at the input end of a 3D image displaying apparatus, the 3D image format converter of the present invention can convert the 3D image signal into a transmission mode that can be received and processed by the 3D image displaying apparatus, and provide the converted 3D image signal to the 3D image displaying apparatus. This will ease consumer trouble in choosing 3D image displaying apparatuses and related products.

To achieve the aforesaid objective, the present invention provides a three-dimension (3D) image format converter, which comprises a memory, an input circuit, a control circuit and an output circuit. The input circuit is configured to receive a first 3D image signal. The first 3D image signal carries a right-eye image data and a left-eye image data. The control circuit is coupled to both the memory and the input circuit and is configured to determine the first permutation way and the second permutation way according to the first 3D image signal belonging to one of the frame transmission mode and the line transmission mode. Next the control circuit writes the right-eye image data and the left-eye image data into the memory in the first permutation way, and then, reads out the right-eye image data and the left-eye image data from the memory in the second permutation way to generate a second 3D image signal. The second 3D image signal belongs to the other of the frame transmission mode and the line transmission mode. The output circuit is coupled to the control circuit and configured to output the second 3D image signal.

Additionally, the present invention further discloses a three-dimension (3D) image format conversion method for a 3D image format converter. The 3D image format converter comprises a memory, an input circuit and a control circuit. The control circuit is coupled to the memory, the input circuit and the output circuit. The 3D image format conversion method comprises the following steps: (a) enabling the input circuit to receive a first 3D image signal carrying a right-eye image data and a left-eye image data; (b) enabling the control circuit to determine a first permutation way and a second permutation way according to the first 3D image signal belonging to one of the frame transmission mode and the line transmission mode; (c) enabling the control circuit to write the right-eye image data and the left-eye image data into the memory in the first permutation way; (d) enabling the control circuit to read out the right-eye image data and the left-eye image data from the memory in the second permutation way to generate a second 3D image signal belonging to the other of the frame transmission mode and the line transmission mode; and (e) enabling the output circuit to output the second 3D image signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a 3D image format converter 1 according to the first embodiment of the present invention;

FIG. 2 is a schematic view of multiple 3D image formats;

FIG. 3 is a schematic view of a 3D image format converter 2 according to the second embodiment and third embodiment of the present invention;

FIG. 4 depicts an implementation in which the right-eye line data r₁˜rₙ and left-eye line data l₁·lₙ are written into a memory 15;

FIG. 5 depicts another implementation in which the right-eye line data r₁˜rₙ and the left-eye line data l₁˜lₙ are written into the memory 15;

FIG. 6 is a schematic view of a 3D image format converter 3 according to the fourth embodiment of the present invention;

FIG. 7 is a flowchart diagram of a 3D image format conversion method according to the fifth embodiment of the present invention; and

FIG. 8 is a flowchart diagram of a 3D image format conversion method according to the sixth embodiment of the present invention.

### DESCRIPTION OF THE PREFERRED EMBODIMENT

In the following descriptions, the present invention will be explained with reference to embodiments thereof. However, these embodiments are not intended to limit the present invention to any environments, applications or implementations described in these embodiments. Therefore, the description of these embodiments is only for purpose of illustration rather than limitation. It shall be appreciated that in the following embodiments and the attached drawings, elements not directly related to the present invention are omitted from depiction.

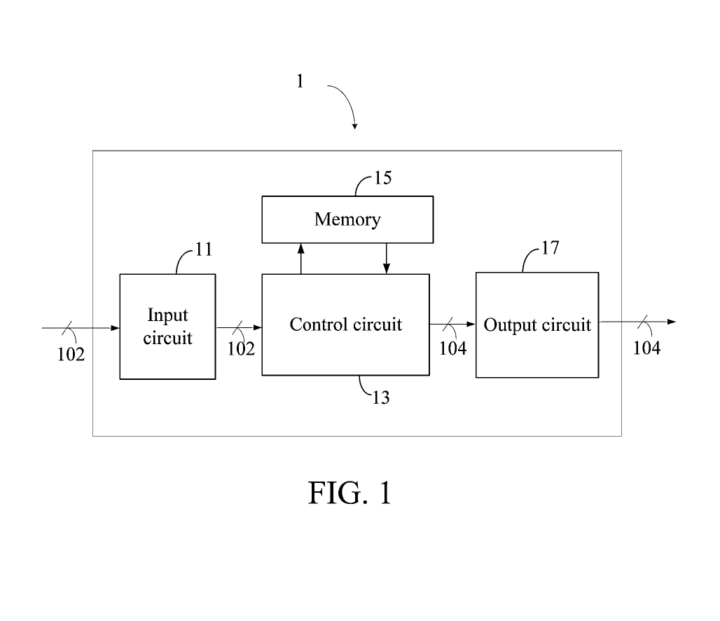

FIG. 1 is a schematic view of a 3D image format converter 1 according to the first embodiment of the present invention. The 3D image format converter 1 comprises an input circuit 11, a control circuit 13, a memory 15 and an output circuit 17. The 3D image format converter 1 can be installed at an input end of a 3D image displaying apparatus (e.g., a liquid crystal display (LCD) screen, an LCD television, a projector or the like) to receive and convert a 3D image signal.

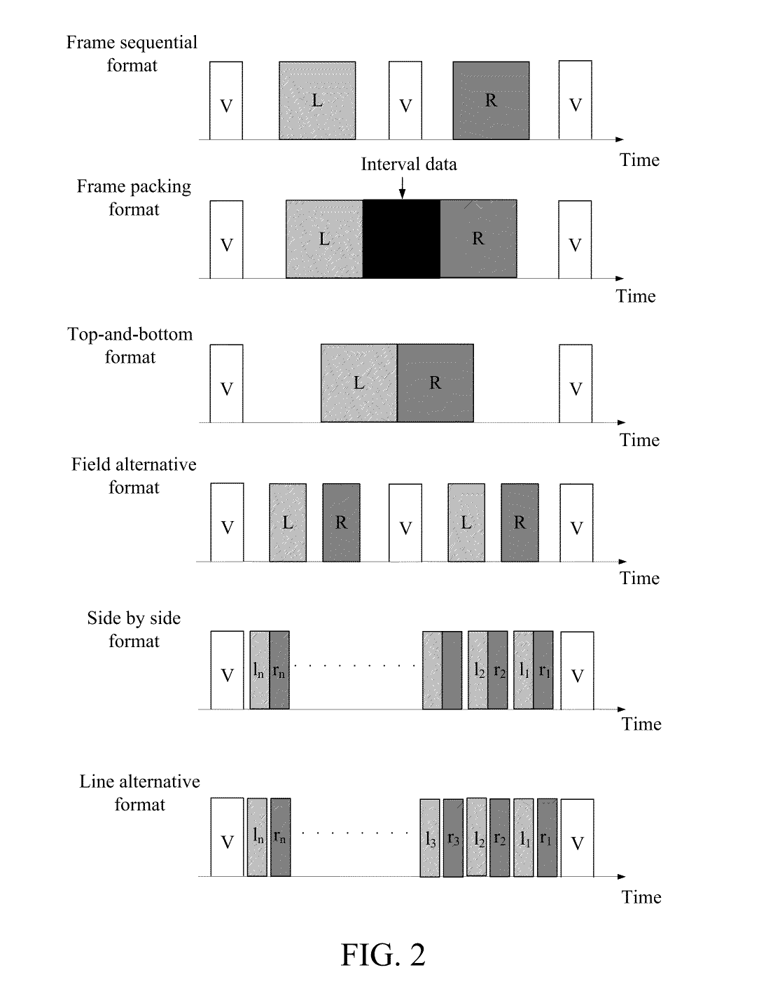

The input circuit 11 may comprise an input interface (e.g., an HDMI) to receive a first 3D image signal 102 from an external multimedia player (not shown) or to receive the first 3D image signal 102 from the input end of the 3D image displaying apparatus. The first 3D image signal 102 carries a right-eye image data R, a left-eye image data L and a vertical synchronization signal V. The right-eye image data R consists of a plurality of right-eye line data r₁˜rₙ, while the left-eye image data L consists of a plurality of left-eye line data l₁˜lₙ. As shown in FIG. 2, the first 3D image signal 102 may be a frame sequential format, a frame packing format, a top-and-bottom format, a field alternative format, a side by side format or a line alternative format. As described previously, the frame sequential format, the frame packing format, the top-and-bottom format and the field alternative format belong to the frame transmission mode, while the side by side format and the line alternative format belong to the line transmission mode.

It shall be appreciated that the aforesaid 3D image signal formats are well known in the prior art. The primary technical contents of the present invention focus on the conversion of the 3D image signal between the frame transmission mode and the line transmission mode, so the details of the 3D image signal formats (e.g., the 3D image signal of the frame packing format further carries an interval data, which corresponds to an active interval) will not be further described herein. The technical means adopted by the present invention to convert the 3D image signal between the frame transmission mode and the line transmission mode can be readily appreciated by those of ordinary skill in the art based on the following description.

The control circuit 13 is coupled to the input circuit 11, the memory 15 and the output circuit 17. The control circuit 13 determines a first permutation way and second permutation way according to the first 3D image signal 102 belonging to one of the frame transmission mode and the line transmission mode. Then, the control circuit 13 writes the right-eye image data R and the left-eye image data L into the memory 15 in the first permutation way, and reads out the right-eye image data R and the left-eye image data L from the memory 15 in the second permutation way to generate a second 3D image signal 104. The second 3D image signal 104 belongs to the other of the frame transmission mode and the line transmission mode.

The output circuit 17 may also comprise an output interface (e.g., an HDMI) to provide the second 3D image signal 104 to the input end of the connected 3D image displaying apparatus or to an image processing circuit of the 3D image displaying apparatus. Accordingly, when the first 3D image signal 102 belongs to the frame transmission mode, the control circuit 13 determines the first permutation way and the second permutation way to write the right-eye image data R and the left-eye image data L into the memory 15 in the first permutation way and to read out the right-eye image data R and the left-eye image data L from the memory 15 in the second permutation way. Thereby, the first 3D image signal 102 can be converted into the second 3D image signal 104 belonging to the line transmission mode.

Likewise, when the first 3D image signal 102 belongs to the line transmission mode, the control circuit 13 determines the first permutation way and the second permutation way to write the right-eye image data R and the left-eye image data L into the memory 15 in the first permutation way and to read out the right-eye image data R and the left-eye image data L from the memory 15 in the second permutation way. Thereby, the first 3D image signal 102 can be converted into the second 3D image signal 104 belonging to the frame transmission mode.

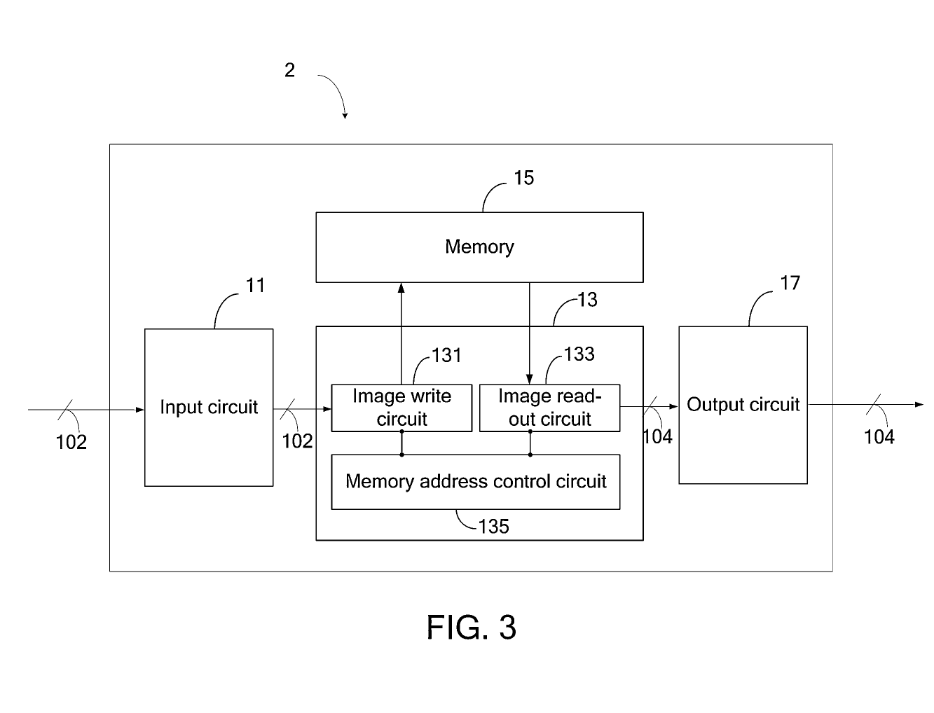

The second embodiment of the present invention is as shown in FIG. 3, which is a schematic view of a 3D image format converter 2. In this embodiment, the control circuit 13 comprises an image write circuit 131, an image read-out circuit 133 and a memory address control circuit 135. The image write circuit 131 is coupled to the input circuit 11 and configured to write the right-eye image data R and the left-eye image data L of the first 3D image signal 102 into the memory 15 in the first permutation way. The image read-out circuit 133 is coupled to the output circuit 17 and configured to read out the right-eye image data R and the left-eye image data L from the memory 15 in the second permutation way to generate the second 3D image signal 104.

The memory address control circuit 135 is coupled to the image write circuit 131 and the image read-out circuit 133 and configured to determine the first permutation way and the second permutation way according to the first 3D image signal 102 belonging to one of the frame transmission mode and the line transmission mode. The memory address control circuit 135 is configured to control the writing operation of the image write circuit 131 in the first permutation way and to control the read-out operation of the image read-out circuit 133 in the second permutation way.

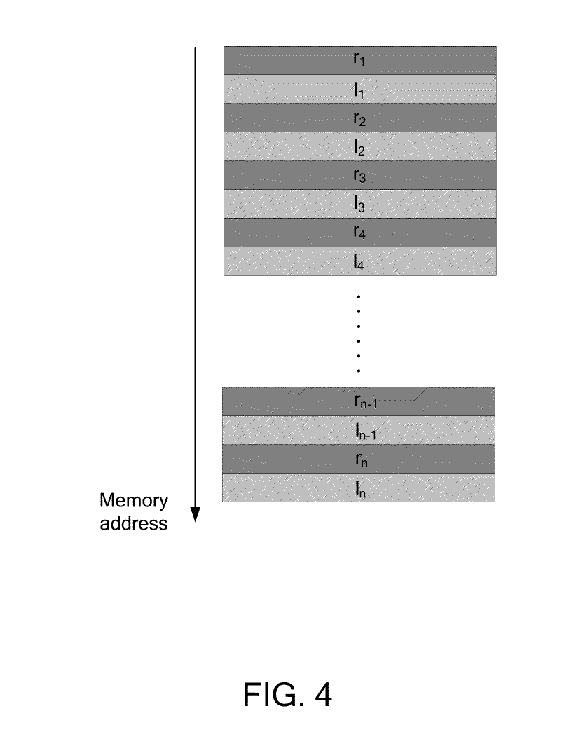

Furthermore, the memory 15 comprises a plurality of memory addresses. When the first 3D image signal 102 belongs to the frame transmission mode and is to be converted into the line transmission mode, the first permutation way is to have the image write circuit 131 interleavingly write the right-eye line data r₁˜rₙ of the right-eye image data and the left-eye line data l₁˜lₙ of the left-eye image data into the memory 15, as shown in FIG. 4. Then, the second permutation way is to have the image read-out circuit 133 sequentially read the data in the sequence of the memory addresses (i.e., interleavingly read out the right-eye line data r₁˜rₙ and the left-eye line data l₁˜lₙ from the memory 15). Thus, the second 3D image signal 104 with the right-eye line data r₁˜rₙ and the left-eye line data l₁˜lₙ that are interleaved with each other can be generated.

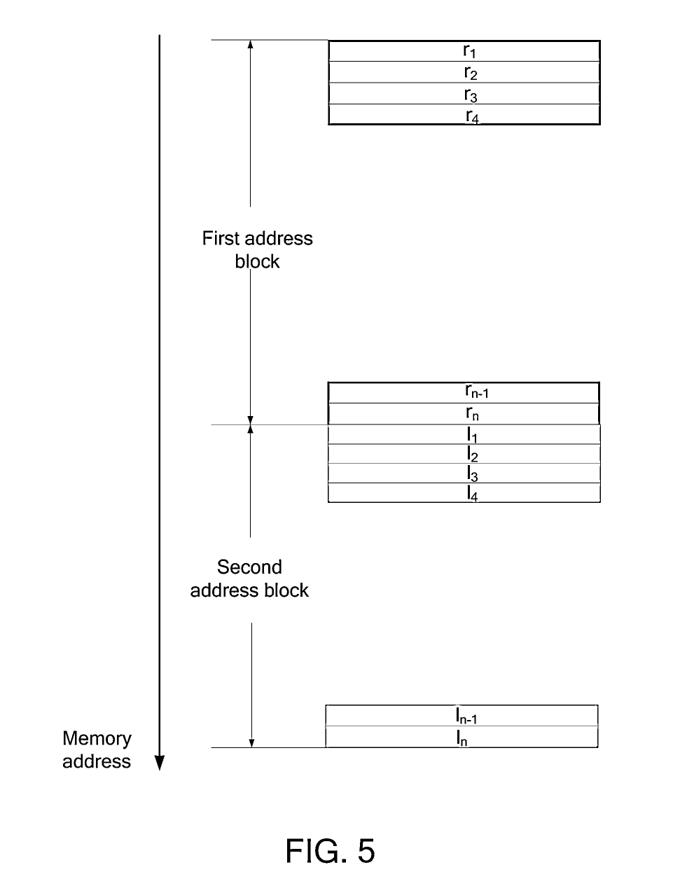

On the other hand, when the first 3D image signal 102 belongs to the line transmission mode and is to be converted into the frame transmission mode, the memory address control circuit 135 divides the memory addresses of the memory 15 into a first address block and a second address block, as shown in FIG. 5. In this case, the first permutation way is to have the image write circuit 131 write the right-eye line data r₁˜rₙ of the right-eye image data R into the first address block and write the left-eye line data l₁˜lₙ of the left-eye image data into the second address block. Then, the second permutation way is to have the image read-out circuit 133 sequentially read the data in the sequence of the memory addresses (i.e., read out the right-eye image data R (i.e., r₁˜rₙ) from the first address block first and then read out the left-eye image data L (i.e., l₁˜lₙ) from the second address block) to generate the second 3D image signal 104 of the frame transmission mode.

As can be known from the above descriptions, the present invention can use the memory address control circuit 135 to control the image write circuit 131 so that different writing ways are adopted to convert the 3D image signal from the line transmission mode into the frame transmission mode or from the frame transmission mode into the line transmission mode. It shall be appreciated that the technical contents of the present invention focus on the conversion between the frame transmission mode and the line transmission mode. The method in which the 3D image signal is converted into a frame sequential format, a frame packing format, a top-and-bottom format, a field alternative format, a side by side format and a line alternative format can be readily appreciated by those of ordinary skill in the art by reference to the technical means disclosed in the present invention and the conventional technical means for generating a 3D image signal, so they will not be further described herein.

The third embodiment of the present invention is also as shown in FIG. 3. The third embodiment is different from the second embodiment in that the memory address control circuit 135 controls the image read-out circuit 133 to adopt different read-out ways so that the 3D image signal is converted from the line transmission mode into the frame transmission mode or from the frame transmission mode into the line transmission mode.

When the first 3D image signal 102 belongs to the frame transmission mode and is to be converted into the line transmission mode, the memory address control circuit 135 divides the memory addresses of the memory 15 into the first address block and the second address block, also as shown in FIG. 5. In this case, the first permutation way is to have the image write circuit 131 sequentially write the data in the sequence of the memory addresses (i.e., write the right-eye image data R (i.e., r₁˜rₙ) into the first address block and write the left-eye image data L (i.e., l₁˜lₙ) into the second address block).

Then, the second permutation way is to have the image read-out circuit 133 interleavingly read out the right-eye line data r₁˜rₙ of the right-eye image data R and the left-eye line data l₁˜lₙ of the left-eye image data L from the first address block and the second address block. For example, the image read-out circuit 133 reads out the right-eye line data r₁ from the first address block, then reads out the left-eye line data l₁ from the second address block, and subsequently reads out the right-eye line data r₂, the left-eye line data l₂, the right-eye line data r₃, the left-eye line data l₃, . . . , the right-eye line data rₙ, and the left-eye line data lₙ. Thus, the second 3D image signal 104 with the right-eye line data r₁˜rₙ and the left-eye line data l₁˜lₙ which are interleaved with each other can be generated.

On the other hand, when the first 3D image signal 102 belongs to the line transmission mode and is to be converted into the frame transmission mode, the first permutation way is to have the image write circuit 131 sequentially write the data in the sequence of the memory addresses (i.e., interleavingly write the right-eye line data r₁˜rₙ of the right-eye image data R and the left-eye line data l₁˜lₙ of the left-eye image data L into the memory 15), as shown in FIG. 4. Then, the second permutation way is to have the image read-out circuit 133 read out the right-eye line data r₁˜rₙ of the right-eye image data R first and then read out the left-eye line data l₁˜lₙ of the left-eye image data L to generate the second 3D image signal 104 of the frame transmission mode.

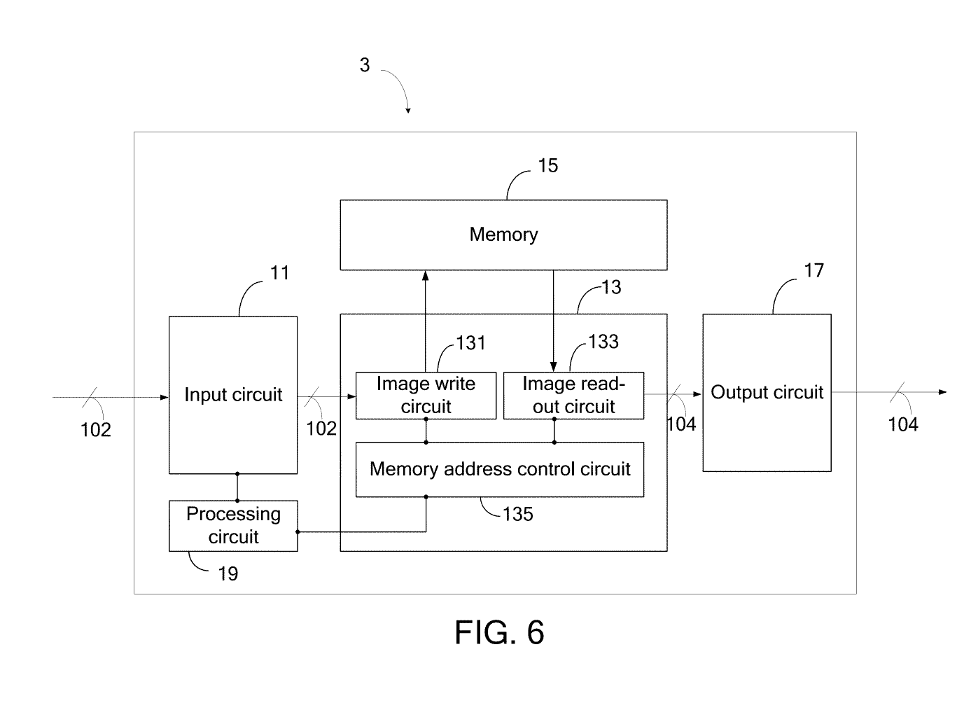

The fourth embodiment of the present invention is as shown in FIG. 6, which is a schematic view of a 3D image format converter 3. Compared to the second embodiment and the third embodiment, the 3D image format converter 3 of the fourth embodiment further comprises a processing circuit 19. The processing circuit 19 is coupled to the input circuit 11 and the memory address control circuit 135, and is configured to retrieve a piece of image information of the first 3D image signal 102. Then, the processing circuit 19 determines that the first 3D image signal 102 belongs to one of the frame transmission mode and the line transmission mode according to the image information, and transmits a determination result to the memory address control circuit 135. Accordingly, the memory address control circuit 135 determines the first permutation way and the second permutation way according to the determination result.

In detail, the transmission mode of the second 3D image signal 104 to be outputted may be set in advance in the processing circuit 19. The first 3D image signal 102 usually carries the information of the 3D image format, so the processing circuit 19 can determine, according to the information, whether the first 3D image signal 102 belongs to the same transmission mode as the second 3D image signal 104 to be outputted. The processing circuit 19 can then transmit the determination result to the memory address control circuit 135 of the control circuit 13. If the determination result indicates that the first 3D image signal 102 belongs to a different transmission mode from the second 3D image signal 104 to be outputted, then the memory address control circuit 135 will determine the first permutation way and the second permutation way as described in the second embodiment and the third embodiment.

However, if the determination result indicates that the first 3D image signal 102 belongs to the same transmission mode as the second 3D image signal 104 to be outputted, then the memory address control circuit 135 will enable the image write circuit 131 to sequentially write the first 3D image signal 102 into the memory 15 in the conventional way and enable the image read-out circuit 133 to sequentially read out the first 3D image signal 102 from the memory 15 to generate the second 3D image signal 104 which is the same as the first 3D image signal 102.

Additionally, the memory address control circuit 135 may also enable the image write circuit 131 to directly transmit the first 3D image signal 102 to the image read-out circuit 133 so that the second 3D image signal 104, which is the same as the first 3D image signal 102, can be directly outputted without the need of using the memory 15. In other words, the input circuit 11 may be directly coupled to the output circuit 17. The processing circuit 19 can enable the input circuit 11 to directly transmit the first 3D image signal 102 to the output circuit 17 to output the second 3D image signal 104 which is the same as the first 3D image signal 102.

In other embodiments, the processing circuit 19 may also be coupled to the output circuit 17. Therefore, apart from setting the transmission mode of the second 3D image signal 104 to be outputted in advance, the processing circuit 19 may also obtain the transmission mode of the second 3D image signal 104 via the output circuit 17 from the image processing circuit of the 3D image displaying apparatus connected to the processing circuit 19.

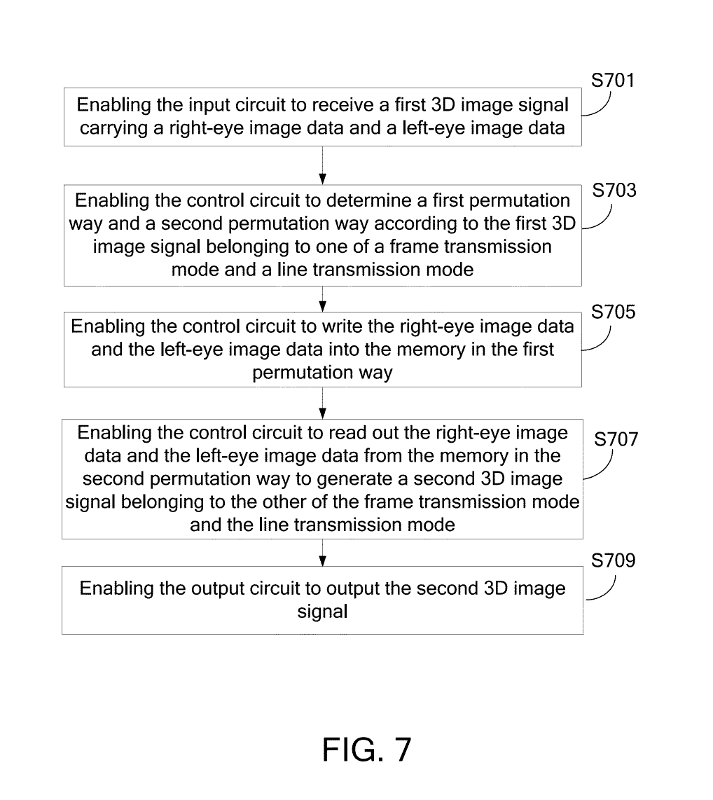

The fifth embodiment of the present invention is as shown in FIG. 7, which is a flowchart diagram of a 3D image format conversion method. The 3D image format conversion method of the present invention is suitable for use in a 3D image format converter, which comprises an input circuit, a control circuit, a memory and an output circuit. The control circuit is coupled to the input circuit, the memory and the output circuit.

Firstly, step S701 is executed to enable the input circuit to receive a first 3D image signal carrying a right-eye image data and a left-eye image data. Then, step S703 is executed to enable the control circuit to determine a first permutation way and a second permutation way according to the first 3D image signal belonging to one of a frame transmission mode and a line transmission mode.

Then, step S705 is executed to enable the control circuit to write the right-eye image data and the left-eye image data into the memory in the first permutation way. Next, step S707 is executed to enable the control circuit to read out the right-eye image data and the left-eye image data from the memory in the second permutation way to generate a second 3D image signal belonging to the other of the frame transmission mode and the line transmission mode. Finally, step S709 is executed to enable the output circuit to output the second 3D image signal.

In addition to the aforesaid steps, the 3D image format conversion method of the fifth embodiment can also execute all the operations and functions set forth in the first embodiment, the second embodiment, the third embodiment or the fourth embodiment. The method in which the fifth embodiment executes these operations and functions can be readily appreciated by those of ordinary skill in the art based on the explanation of the first embodiment, the second embodiment, the third embodiment or the fourth embodiment, and thus, will not be further described herein.

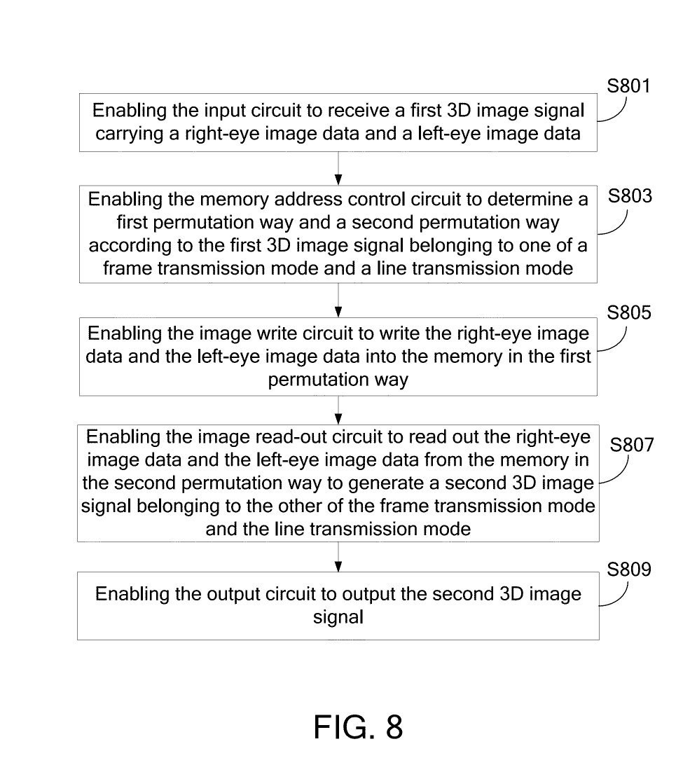

The sixth embodiment of the present invention is as shown in FIG. 8, which is a flowchart diagram of a 3D image format conversion method. The 3D image format conversion method of the present invention is suitable for use in a 3D image format converter, which comprises an input circuit, a control circuit, a memory and an output circuit. The control circuit comprises an image write circuit, an image read-out circuit and a memory address control circuit. The image write circuit is coupled to the input circuit, while the image read-out circuit is coupled to the output circuit. The memory address control circuit is coupled to the image write circuit and the image read-out circuit. A processing circuit is coupled to the input circuit and the memory address control circuit.

Firstly, step S801 is executed to enable the input circuit to receive a first 3D image signal carrying a right-eye image data and a left-eye image data. Then, step S803 is executed to enable the memory address control circuit to determine a first permutation way and a second permutation way according to the first 3D image signal belonging to one of a frame transmission mode and a line transmission mode.

Then, step S805 is executed to enable the image write circuit to write the right-eye image data and the left-eye image data into the memory in the first permutation way. Next, step S807 is executed to enable the image read-out circuit to read out the right-eye image data and the left-eye image data from the memory in the second permutation way to generate a second 3D image signal belonging to the other of the frame transmission mode and the line transmission mode. Finally, step S809 is executed to enable the output circuit to output the second 3D image signal.

In addition to the aforesaid steps, the 3D image format conversion method of the sixth embodiment can also execute all the operations and functions set forth in the first embodiment, the second embodiment, the third embodiment or the fourth embodiment. The method in which the sixth embodiment executes these operations and functions can be readily appreciated by those of ordinary skill in the art based on the explanation of the first embodiment, the second embodiment, the third embodiment or the fourth embodiment, and thus, will not be further described herein.

According to the above descriptions, the 3D image format converter of the present invention can convert a 3D image signal between the frame transmission mode and the line transmission mode by controlling the way of writing the right-eye image data and the left-eye image data of the 3D image signal into the memory and the way of reading out the right-eye image data and the left-eye image data of the 3D image signal from the memory. Accordingly, when being installed at an input end of a 3D image displaying apparatus, the 3D image format converter of the present invention can convert the 3D image signal into a transmission mode that can be received and processed by the 3D image displaying apparatus, and provide the converted 3D image signal to the 3D image displaying apparatus. This will ease consumer trouble in choosing 3D image displaying apparatuses and related products.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A three-dimension (3D) image format converter, comprising:
a memory;
an input circuit, being configured to receive a first 3D image signal carrying a right-eye image data and a left-eye image data;
a control circuit, being coupled to the memory and the input circuit and configured to determine a first permutation way and a second permutation way according to the first 3D image signal belonging to one of a frame transmission mode and a line transmission mode, write the right-eye image data and the left-eye image data into the memory in the first permutation way, and read out the right-eye image data and the left-eye image data from the memory in the second permutation way to generate a second 3D image signal belonging to the other of the frame transmission mode and the line transmission mode; and
an output circuit, being coupled to the control circuit and configured to output the second 3D image signal.

2. The 3D image format converter as claimed in claim 1, wherein the control circuit comprises:
an image write circuit, being coupled to the input circuit and configured to write the right-eye image data and the left-eye image data into the memory in the first permutation way;
an image read-out circuit, being coupled to the output circuit and configured to read out the right-eye image data and the left-eye image data from the memory in the second permutation way to generate the second 3D image signal; and
a memory address control circuit, being coupled to the image write circuit and the image read-out circuit and configured to determine the first permutation way and the second permutation way according to the first 3D image signal belonging to one of the frame transmission mode and the line transmission mode, and control the image write circuit and the image read-out circuit.

3. The 3D image format converter as claimed in claim 2, wherein when the first 3D image signal belongs to the frame transmission mode, the first permutation way makes the image write circuit interleavingly write a plurality of right-eye line data of the right-eye image data and a plurality of left-eye line data of the left-eye image data into the memory, and the second permutation way makes the image read-out circuit interleavingly read out the right-eye line data of the right-eye image data and the left-eye line data of the left-eye image data from the memory.

4. The 3D image format converter as claimed in claim 2, wherein when the first 3D image signal belongs to the line transmission mode, the memory address control circuit divides a plurality of memory addresses of the memory into a first address block and a second address block, the first permutation way makes the image write circuit write a plurality of right-eye line data of the right-eye image data into the first address block and write a plurality of left-eye line data of the left-eye image data into the second address block, and the second permutation way makes the image read-out circuit read out the right-eye image data from the first address block first and then read out the left-eye image data from the second address block.

5. The 3D image format converter as claimed in claim 2, wherein when the first 3D image signal belongs to the frame transmission mode, the memory address control circuit divides a plurality of memory addresses of the memory into a first address block and a second address block, the first permutation way makes the image write circuit write the right-eye image data into the first address block and write the left-eye image data into the second address block, and the second permutation way makes the image read-out circuit interleavingly read out a plurality of right-eye line data of the right-eye image data and a plurality of left-eye line data of the left-eye image data from the first address block and the second address block.

6. The 3D image format converter as claimed in claim 2, wherein when the first 3D image signal belongs to the line transmission mode, the first permutation way makes the image write circuit interleavingly write a plurality of right-eye line data of the right-eye image data and a plurality of left-eye line data of the left-eye image data into the memory, and the second permutation way makes the image read-out circuit read out the right-eye line data of the right-eye image data and then read out the left-eye line data of the left-eye image data.

7. The 3D image format converter as claimed in claim 2, further comprising a processing circuit coupled to the input circuit and the memory address control circuit, wherein the processing circuit is configured to retrieve a piece of image information of the first 3D image signal to determine that the first 3D image signal belongs to one of the frame transmission mode and the line transmission mode according to the image information, and to transmit a determination result to the memory address control circuit, and the memory address control circuit determines the first permutation way and the second permutation way according to the determination result.

8. The 3D image format converter as claimed in claim 7, wherein the processing circuit determines that the first 3D image signal belongs to the frame transmission mode according to the first 3D image signal belonging to one of a frame sequential format, a frame packing format, a top-and-bottom format and a field alternative format, and determines that the first 3D image signal belongs to the line transmission mode according to the first 3D image signal belonging to one of a side by side format and a line alternative format.

9. A three-dimension (3D) image format conversion method for a 3D image format converter, the 3D image format converter comprising a memory, an input circuit, a control circuit and an output circuit, the control circuit being coupled to the memory, the input circuit and the output circuit, the 3D image format conversion method comprising the following steps:
(a) enabling the input circuit to receive a first 3D image signal carrying a right-eye image data and a left-eye image data;
(b) enabling the control circuit to determine a first permutation way and a second permutation way according to the first 3D image signal belonging to one of a frame transmission mode and a line transmission mode;
(c) enabling the control circuit to write the right-eye image data and the left-eye image data into the memory in the first permutation way;
(d) enabling the control circuit to read out the right-eye image data and the left-eye image data from the memory in the second permutation way to generate a second 3D image signal belonging to the other of the frame transmission mode and the line transmission mode; and
(e) enabling the output circuit to output the second 3D image signal.

10. The 3D image format conversion method as claimed in claim 9, wherein the control circuit comprises an image write circuit, an image read-out circuit and a memory address control circuit, the image write circuit is coupled to the input circuit, the image read-out circuit is coupled to the output circuit, the memory address control circuit is coupled to the image write circuit and the image read-out circuit and configured to control the image write circuit and the image read-out circuit, the step (b) is to enable the memory address control circuit to determine the first permutation way and the second permutation way according to the first 3D image signal belonging to one of the frame transmission mode and the line transmission mode, the step (c) is to enable the image write circuit to write the right-eye image data and the left-eye image data into the memory in the first permutation way, and the step (d) is to enable the image read-out circuit to read out the right-eye image data and the left-eye image data from the memory in the second permutation way to generate the second 3D image signal.

11. The 3D image format conversion method as claimed in claim 10, wherein when the first 3D image signal belongs to the frame transmission mode, the first permutation way makes the image write circuit interleavingly write a plurality of right-eye line data of the right-eye image data and a plurality of left-eye line data of the left-eye image data into the memory, and the second permutation way makes the image read-out circuit interleavingly read out the right-eye line data of the right-eye image data and the left-eye line data of the left-eye image data from the memory.

12. The 3D image format conversion method as claimed in claim 10, wherein when the first 3D image signal belongs to the line transmission mode, the memory address control circuit divides a plurality of memory addresses of the memory into a first address block and a second address block, the first permutation way makes the image write circuit write a plurality of right-eye line data of the right-eye image data into the first address block and write a plurality of left-eye line data of the left-eye image data into the second address block, and the second permutation way makes the image read-out circuit read out the right-eye image data from the first address block and then read out the left-eye image data from the second address block.

13. The 3D image format conversion method as claimed in claim 10, wherein when the first 3D image signal belongs to the frame transmission mode, the memory address control circuit divides a plurality of memory addresses of the memory into a first address block and a second address block, the first permutation way makes the image write circuit write the right-eye image data into the first address block and write the left-eye image data into the second address block, and the second permutation way makes the image read-out circuit interleavingly read out a plurality of right-eye line data of the right-eye image data and a plurality of left-eye line data of the left-eye image data from the first address block and the second address block.

14. The 3D image format conversion method as claimed in claim 10, wherein when the first 3D image signal belongs to the line transmission mode, the first permutation way makes the image write circuit interleavingly write a plurality of right-eye line data of the right-eye image data and a plurality of left-eye line data of the left-eye image data into the memory, and the second permutation way makes the image read-out circuit read out the right-eye line data of the right-eye image data and then read out the left-eye line data of the left-eye image data.

15. The 3D image format conversion method as claimed in claim 10, wherein the 3D image format converter further comprises a processing circuit coupled to the input circuit and the memory address control circuit, and the 3D image format conversion method further comprises the following steps before the step (b):
(f1) enabling the processing circuit to retrieve a piece of image information of the first 3D image signal;
(f2) enabling the processing circuit to determine that the first 3D image signal belongs to one of the frame transmission mode and the line transmission mode according to the image information; and
(f3) enabling the processing circuit to transmit a determination result to the memory address control circuit;
wherein the step (b) is to enable the memory address control circuit to determine the first permutation way and the second permutation way according to the determination result.

16. The 3D image format conversion method as claimed in claim 15, wherein the step (f2) is to enable the processing circuit to determine that the first 3D image signal belongs to the frame transmission mode according to the first 3D image signal belonging to one of a frame sequential format, a frame packing format, a top-and-bottom format and a field alternative format, and to determine that the first 3D image signal belongs to the line transmission mode according to the first 3D image signal belonging to one of a side by side format and a line alternative format.
